(19) United States
(12) Patent Application Publication
(10) Pub. No.: US 2021/0135994 A1
(43) Pub. Date: May 6, 2021

(54) Network topology division method and device, storage medium and electronic device

(71) Applicant: ZTE Corporation, Shenzhen (CN)

(72) Inventor: Xiaobing NIU, Shenzhen (CN)

(21) Appl. No.: 16/967,259

(22) PCT Filed: Feb. 26, 2019
(86) PCT No.: PCT/CN2019/076191

§ 371 Date: Aug. 4, 2020

(30) Foreign Application Priority Data
May 3, 2018 (CN) 201810416491.6

(51) Int. Cl. H04L 12/803; H04L 12/891; H04L 12/26; H04L 12/24

(52) U.S. Cl. CPC H04L 47/125; H04L 47/41; H04L 41/12; H04L 43/0882; H04L 43/0811

(57) ABSTRACT

Provided are a network topology division method and device, a storage medium and an electronic device. The method includes that: a topology division request of a Virtual Network (VN) is received, the topology division request containing Identifier (ID) information of a specified VN to be divided, a type of a division line and a position of the division line; a Traffic Engineering (TE) topology of the specified VN is divided according to the type of the division line and the position of the division line, the specified VN including a TE node and a TE link; and a new VN topology is constructed according to a TE node obtained by division and a TE link obtained by division.

### CROSS-REFERENCE TO RELATED APPLICATIONS

The present application is filed based upon and claims priority to Chinese Patent Application No. 201810416491.6, filed on May 3, 2018, the contents of which are hereby incorporated by reference in its entirety.

### TECHNICAL FIELD

The present disclosure relates, but not limited, to the field of communication, and particularly to a network topology division method and device, a storage medium and an electronic device.

### BACKGROUND

In a related art, Software Defined Networking (SDN) may separate network forwarding and control, improving an operation and maintenance capability of a network operating company and bringing convenience to use of network service by a lessee. Network Function Virtualization (NFV) makes it possible to realize a dedicated network function on a universal software/hardware platform, reducing network investments and operation and maintenance cost. In addition, by software-based NFV, a network infrastructure provider may utilize resources more efficiently and provide network function service more flexibly.

In the related art, the Traffic Engineering Architecture and Signaling (TEAS) work group of the Internet Engineering Task Force (IETF) is committed to researches on Abstraction and Control of Traffic Engineering Networks (ACTN) and proposes an ACTN architecture, including three layers of controller architectures, i.e., a Customer Network Controller (CNC), a Multi-Domain Service Coordinator (MDSC) and a Provisioning Network Controller (PNC), and a related CNC-MDSC Interface (CMI) and MDSC-PNC Interface (MPI). As shown in FIG. 1, FIG. 1 is a diagram of a network architecture according to the related art.

The CNC mainly initiates a Virtual Network (VN) service request and accepts a VN service response of the MDSC.

The MDSC is mainly responsible for service and network coordination between multiple domains.

The PNC mainly implements resource control of an underlying network, reports a network topology to an upper-layer controller (for example, the MDSC) and maintains a network connection.

The CMI is an interface between the CNC and the MDSC, and the MPI is an interface between the MDSC and the PNC. The CMI supports a VN operation, and a Traffic Engineering (TE) operation is completed at the MPI, so that basic operations of VN creation, deletion, refreshing and the like may be implemented.

In ACTN, two types of VNs are proposed, one being a TE tunnel and the other being a VN topology. The VN topology is formed by TE nodes and TE links in form of a “diagram”. Herein, the TE node may be a physical network node and may also be a TE supporting node abstracted from a physical network. Herein, the TE link may include multiple member links.

For the VN topology provided for the CNC, the whole topology network is directly managed according to a solution in the related art, and difficulties in management are relatively great.

### SUMMARY

In view of this, embodiments of the present disclosure are intended to provide a network topology division method and device, a storage medium and an electronic device.

The embodiments of the present disclosure provide a network topology division method, which may include that: a topology division request of a VN is received, the topology division request containing Identifier (ID) information of a specified VN to be divided, a type of a division line and a position of the division line; a TE topology of the specified VN is divided according to the type of the division line and the position of the division line, the specified VN including a TE node and a TE link; and a new VN topology is constructed according to a TE node obtained by division and a TE link obtained by division.

The embodiments of the present disclosure also provide a network topology division device, which may include: a receiving module, configured to receive topology division request of a VN, the topology division request containing ID information of a specified VN to be divided, a type of a division line and a position of the division line; a division module, configured to divide a TE topology of the specified VN according to the type of the division line and the position of the division line, the specified VN including a TE node and a TE link; and a construction module, configured to construct a new VN topology according to a TE node obtained by division and a TE link obtained by division.

The embodiments of the present disclosure also provide a storage medium, in which a computer program may be stored, the computer program being configured to run to execute the network topology division method provided in the embodiments of the present disclosure.

The embodiments of the present disclosure also provide an electronic device, which may include a memory and a processor. A computer program may be stored in the memory. The processor may be configured to run the computer program to execute the network topology division method provided in the embodiments of the present disclosure.

Through the embodiments of the present disclosure, division of a VN topology is implemented, the technical problem in the related art that the VN topology may not be divided is solved, division of the VN topology is implemented, and a complex VN may be conveniently managed and controlled.

### BRIEF DESCRIPTION OF THE DRAWINGS

FIG. 1 is a diagram of a network architecture according to the related art;

FIG. 2 is a flowchart of a network topology division method according to an embodiment of the present disclosure;

FIG. 3 is a structure block diagram of a network topology division device according to an embodiment of the present disclosure;

FIG. 4 is a schematic diagram of longitudinal cutting and division results of a TE link according to an embodiment of the present disclosure;

FIG. 5 is a schematic diagram of longitudinal cutting and division results of a TE node according to an embodiment of the present disclosure;

FIG. 6 is a schematic diagram of transverse cutting and division results of a TE link according to an embodiment of the present disclosure;

FIG. 7 is a schematic diagram of a VN topology division system according to an embodiment of the present disclosure;

FIG. 8 is a schematic diagram of an initial VN topology according to an embodiment of the present disclosure; and

FIG. 9 is a schematic diagram of VN topologies obtained by division according to an embodiment of the present disclosure.

### DETAILED DESCRIPTION OF THE EMBODIMENTS

The present disclosure will be described below with reference to the drawings and in combination with the embodiments in detail. It is to be noted that the embodiments in the present application and characteristics in the embodiments may be combined without conflicts.

It is to be noted that the terms like “first” and “second” in the specification, claims and accompanying drawings of the present disclosure are used for differentiating the similar objects, but do not have to describe a specific order or a sequence.

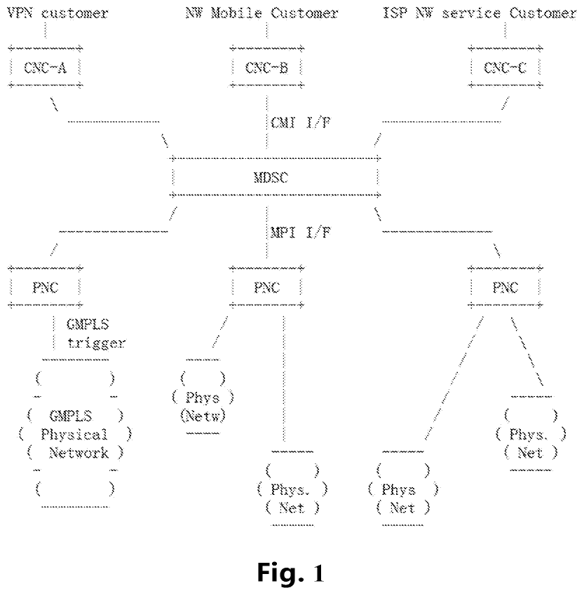

The embodiments of the present application may run in a network architecture shown in FIG. 1. As shown in FIG. 1, the network architecture includes three layers of controller architectures, i.e., a CNC, an MDSC and a PNC. A CMI I/F is an interface between the CNC and the MDSC, and an MPI I/F is an interface between the MDSC and the PNC. Generalized Multi-Protocol Label Switching (GMPLS) refers to generalized multi-protocol label switching, Phys.Net is an abbreviation of physical network and refers to a physical network.

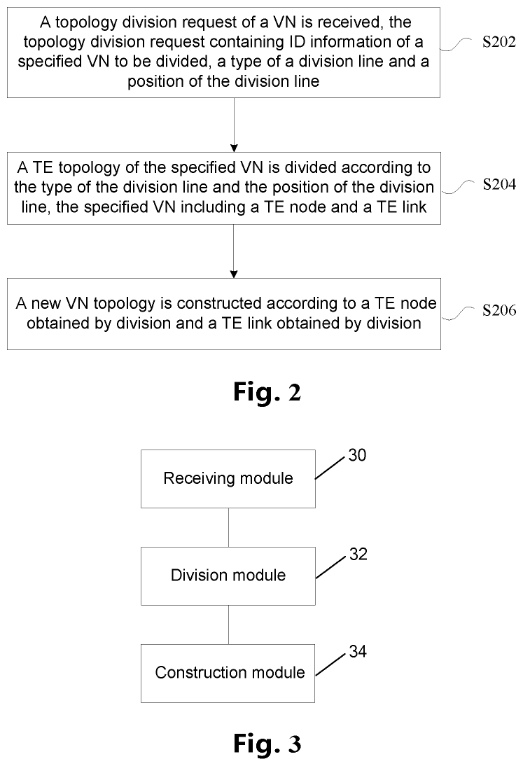

The embodiments of the present disclosure provide a network topology division method running in the abovementioned network architecture. FIG. 2 is a flowchart of a network topology division method according to an embodiment of the present disclosure. As shown in FIG. 2, the flow includes the following steps.

In S202, a topology division request of a VN is received, the topology division request containing ID information of a specified VN to be divided, types of one or more division lines and positions, corresponding to the types of the division lines, of the one or more division lines.

In S204, a TE topology of the specified VN is divided according to the type of the division line and the position of the division line, the specified VN includes at least one TE node and one TE link.

In S206, a new VN topology is constructed according to the TE nodes obtained by division and the TE links obtained by division.

Through the steps, division of a VN topology is implemented, the technical problem in the related art that the VN topology may not be divided is solved, division of the VN topology is implemented, and a complex VN may be conveniently managed and controlled.

In an embodiment, an execution body of the steps may be, but not limited to, a controller, a control server, a network element, an MDSC and the like.

In an embodiment, the type of the division line may be, but not limited to, longitudinal cutting of the TE link, configured to represent that the TE link between two TE nodes is divided into two TE links with single ends opened; longitudinal cutting of the TE node, configured to represent that a TE node is divided into two or more parts; and transverse cutting of the TE link, configured to represent that a specified TE link including end nodes is divided into multiple TE links.

In an embodiment, the operation that the TE topology of the specified VN is divided according to the type of the division line and the position of the division line includes that: the TE node and/or the TE link are/is divided at the position of the division line according to the type of the division line for the TE topology.

In an embodiment, the operation that the TE topology is constructed according to the type of the division line and the position of the division line includes the following steps.

In S21, TE nodes and/or TE links to be divided are determined according to the types of the division lines and the positions of the division lines.

In S22, the TE topology is constructed according to a connectivity relationship of the TE nodes obtained by division and/or the TE links obtained by division.

In an embodiment, the operation that the TE node and/or TE link to be divided are/is determined according to the type of the division line and the position of the division line includes at least one of that:

when the type of the division line is longitudinal cutting of the TE link, the TE link to be divided is specified through a TE link ID;

when the type of the division line is longitudinal cutting of the TE node, the TE node to be divided is specified through a TE node ID; and

when the type of the division line is transverse cutting of the TE link, the TE link to be divided and end nodes of the TE link are specified through the TE link ID.

In an embodiment, the operation that the TE node and/or the TE link are/is divided at the position of the division line according to the type of the division line for the TE topology includes at least one of that:

when the type of the division line is longitudinal cutting of the TE link, a first TE link is divided into one or two second TE links with single ends opened at the position of the division line;

when the type of the division line is longitudinal cutting of the TE node, a first TE node is divided into one or two second TE nodes at the position of the division line; and
when the type of the division line is transverse cutting of the TE link, a third TE link is divided into multiple fourth TE links at the position of the division line, and a first end node of the third TE link is divided into a corresponding second end node. There are two conditions for a TE link: one is that there are nodes at both ends, and the other is that a single end is opened. When there are nodes at the both ends, the nodes at the two ends are correspondingly divided into two nodes, and when the single end is opened, the node at the single end is correspondingly divided into a single node.

In an embodiment, after the TE node and/or the TE link are/is divided at the position of the division line according to the type of the division line for the TE topology, configuration information of the node or link obtained by division may further be updated. When the type of the division line is longitudinal cutting of the TE link, after the first TE link is divided into the one or two second TE links with the single ends opened at the position of the division line, configuration information of the second TE link is updated. When the type of the division line is longitudinal cutting of the TE node, after the first TE node is divided into the two second TE nodes at the position of the division line, configuration information of the second TE node is updated. When the type of the division type is transverse cutting of the TE link, after the third TE link is divided into the multiple fourth links at the position of the division line and the first end node of the third TE link is divided into the corresponding second end node, configuration information of the fourth TE link and configuration information of the second end node are updated.

Through the above descriptions about the implementation modes, those skilled in the art may clearly know that the methods according to the embodiment may be implemented in a manner of combining software and a required universal hardware platform and, of course, may also be implemented through hardware, but the former is a preferred implementation mode under many circumstances. Based on such an understanding, the technical solutions of the present disclosure substantially or parts making contributions to a conventional art may be embodied in form of a software product. The computer software product is stored in a storage medium (for example, a Read-Only Memory (ROM)/Random Access Memory (RAM), a magnetic disk and an optical disk), including a plurality of instructions configured to enable a terminal device (which may be a mobile phone, a computer, a server, a network device or the like) to execute the method of each embodiment of the present disclosure.

The embodiments of the present disclosure also provide a network topology division device, which is configured to implement the abovementioned embodiment. What has been described will not be elaborated. For example, term “module” used below may be a combination of software and/or hardware capable of realizing a preset function. Although the device described in the following embodiment is preferably implemented with software, implementation with hardware or a combination of the software and the hardware is also possible and conceivable.

FIG. 3 is a structure block diagram of a network topology division device according to an embodiment of the present disclosure. As shown in FIG. 3, the device includes:

a receiving module 30, configured to receive a topology division request of a VN, the topology division request containing ID information of a specified VN to be divided, a type of a division line and a position of the division line;
a division module 32, configured to divide a TE topology of the specified VN according to the type of the division line and the position of the division line, the specified VN including a TE node and a TE link; and
a construction module 34, configured to construct a new VN topology according to a TE node obtained by division and a TE link obtained by division.
In an embodiment, the division module includes a division unit, configured to divide the

TE node and/or the TE link at the position of the division line according to the type of the division line for the TE topology.

In an embodiment, the type of the division line may be, but not limited to, longitudinal cutting of the TE link, configured to represent that the TE link between two TE nodes is divided into two TE links with single ends opened; longitudinal cutting of the TE node, configured to represent that a TE node is divided into two or more parts; and transverse cutting of the TE link, configured to represent that a specified TE link including end nodes is divided into multiple TE links.

It is to be noted that each module may be implemented through software or hardware and, under the latter condition, may be implemented in, but not limited to, the following manner: the modules are all positioned in the same processor, or the modules are positioned in different processors in any combination form respectively.

According to the embodiment, for a VN topology provided for a CNC, the CNC, considering convenience for management and the like, requests an MDSC for dividing the VN topology into multiple small topologies, and each small topology may be independently managed and controlled.

In some embodiments, a VN topology division method and system are also provided. Based on the method and the system, VN topology division may be implemented based on a TE link and a TE node.

For conveniently describing division of a TE topology, the following division lines are defined in the embodiment.

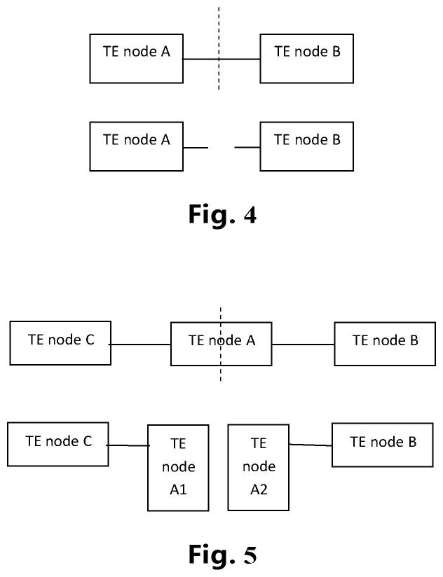

The type of the division line is longitudinal cutting of the TE link. Referring to FIG. 4, FIG. 4 is a schematic diagram of longitudinal cutting and division results of a TE link according to an embodiment of the present disclosure. The dotted line represents the division line, and the division line is between two nodes of the TE link and divides the TE link into two TE links with single ends opened. A TE link originally with a single end opened is divided into TE links still with single ends opened by the division line of this type.

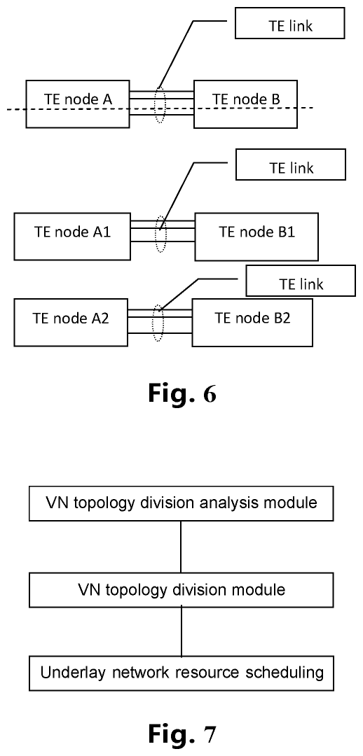

The type of the division line is longitudinal cutting of the TE node. Referring to FIG. 5, FIG. 5 is a schematic diagram of longitudinal cutting and division results of a TE node according to an embodiment of the present disclosure. The dotted line represents the division line, and the division line runs through the TE node and may not divide another TE link, namely one TE node is divided into two or more parts and each part may be in different TE topologies.
The type of the division line is transverse cutting of the TE link. Referring to FIG. 6, FIG. 6 is a schematic diagram of transverse cutting and division results of a TE link. The dotted line represents the division line, the division line subdivides a specified TE link (including end nodes) into multiple TE links, and these links may be in different TE topologies.

The technical solution of the embodiment includes the following contents.

A first controller receives a VN topology division request, the request at least containing an ID of a VN topology to be divided, which may be represented with VN Topology ID, and a type and position of a division line.

The first controller receives the VN topology division request, the request further containing a VN topology alias obtained by division.

A VN TE topology is constructed according to the type and position of the division line, including the following operations.

A TE node and a TE link are divided according to the type and position of each division line:

when the type of the division line is longitudinal cutting of the TE link, the division line divides a TE link at a specified position into one or two TE links with single ends opened, the position being specified through a TE link ID;

when the type of the division line is longitudinal cutting of the TE node, one TE node is divided into two TE nodes and the corresponding TE link is also divided to the new TE nodes, the position being specified through a TE node ID; and

when the type of the division line is transverse cutting of the TE link, the specified TE link is divided into multiple TE links and end nodes of the TE line are also divided, the position being specified through a TE link ID.

Connectivity relationships of a TE node and TE link not involved in division are kept unchanged.

One or more VN topologies are constructed according to connectivity relationships of the TE node and TE link obtained by division.

The first controller configures the topology alias in the request in the corresponding VN topology.

The type and position of each division line in the request are analyzed, and division of the TE link and the TE node is executed. The following steps are included.

If the type of the division line is longitudinal cutting of the TE link, the division line divides the TE link into one or two TE links with single ends opened, the topology where the TE link obtained by division is located being determined by the first controller, and a TE link attribute configuration is updated, at least including link bundle information, underlay TE topology and TE link layer network attributes.

If the type of the division line is longitudinal cutting of the TE node, one TE node is divided into two TE nodes, the first controller schedules an underlay network resource according to the VN topology where the new TE node generated by division is located and an underlay network diversity requirement, and updates a TE node configuration, at least including a new TE node ID, connectivity matrices, an underlay TE topology and the like, and a TE link attribute configuration in the new TE node is updated, at least including the link bundle information, underlay TE topology and TE link layer network attributes; and

when the type of the division line is transverse cutting of the TE link, the specified TE link is divided into multiple TE links and end nodes of the TE line are also divided, the first controller schedules an underlay network resource according to the VN topology where the TE node and TE link obtained by division are located, a TE link bandwidth and the underlay network diversity requirement, and if there are multiple layers of VNs, nests and calls the underlay network resource and updates the generated new TE node configuration, at least including the TE node ID, the connectivity matrices, the underlay TE topology and the like, and the TE link attribute configuration is updated, at least including the link bundle information, underlay TE topology and TE link layer network attributes.

On another aspect, the embodiment also provides the VN topology division system. FIG. 7 is a schematic diagram of a VN topology division system. The system includes:

a VN topology division analysis module, configured to construct a VN TE topology according to a type and position of a division line;

a VN topology division module, configured to analyze the type and position of each division line in a request, execute division of a TE link and a TE node and construct a new VN topology according to a TE node and TE link obtained by division; and

an underlay network resource scheduling module, configured to schedule an underlay network resource according to a bandwidth requirement of the TE node and TE link of the VN topology.

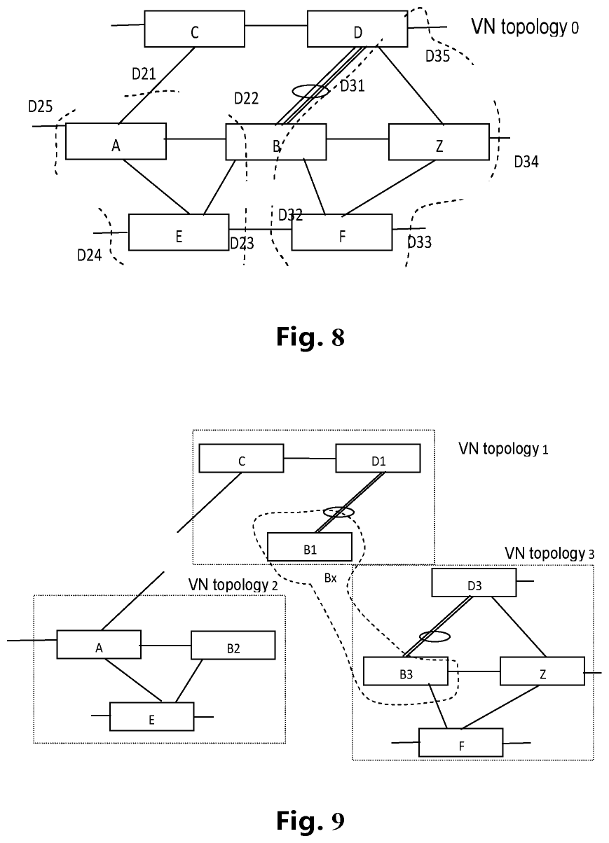

In some embodiments, an initial VN topology is shown in FIG. 8. FIG. 8 is a schematic diagram of an initial VN topology according to an embodiment of the present disclosure. TE nodes {A, B, C, D, E, F, Z} are included.

In FIG. 8, the dotted line represents virtual topology division lines, including D21, D22, D23, D24, D25, D31, D32, D33, D34 and D35.

Longitudinal cutting of the TE link involves D21, D23, D24, D25, D32, D33, D34 and D35.

Longitudinal cutting of the TE node involves D22.

Transverse cutting of the TE link involves D31.

A division process is as follows.

A first controller receives a VN topology division request. For example, an MDSC receives a VN topology division request of a CNC. The request at least contains:

an ID of a VN topology to be divided, which is VN topology 0 in the embodiment; and

the type and position of the division line, the division line including D21, D22, D23, D24, D25, D31, D32, D33, D34 and D35 and position information being represented with TE node and TE link IDs.

For example, 1) the first controller receives the VN topology division request, the request further containing:

a VN topology alias obtained by division, including VN topologies 1, 2 and 3.

A VT TE topology is constructed according to the type and position of the division line, including the following operations.

A TE node and a TE link are divided according to the type and position of each division line:

when the type of the division line is longitudinal cutting of the TE link, the division line divides a TE link at a specified position into one or two TE links with single ends opened, the position being specified through a TE link ID. For example, D21 divides the TE link between the nodes AC into two TE links with single ends opened. For example, D25 divides the TE link into a TE link with a single end opened.

When the type of the division line is longitudinal cutting of the TE node, one TE node is divided into two TE nodes and the corresponding TE link is also divided to the new TE nodes, the position being specified through a TE node ID. For example, the division line D22 divides the node B into two TE nodes (B1 and Bx).

When the type of the division line is transverse cutting of the TE link, the specified TE link is divided into multiple TE links and end nodes of the TE line are also divided, the position being specified through the TE link ID. For example, the division line D31 divides the TE link between the nodes Bx into two parts, the node Bx is divided into TE nodes B1 and B3, and the node D is divided into TE nodes D1 and D3.

Connectivity relationships of a TE node and TE link not involved in division are kept unchanged. For example, connectivity relationships between the nodes CD, between the nodes AE, between the nodes DZ and between the nodes FZ in the topological diagram are kept unchanged.

In the embodiment, three VN topologies are constructed according to connectivity relationships of the TE nodes and TE links obtained by division.

The first controller configures the topology alias in the request in the corresponding VN topology.

The type and position of each division line in the request are analyzed, and division of the TE link and the TE node is executed. FIG. 9 is a schematic diagram of VN topologies obtained by division according to an embodiment of the present disclosure. The following steps are included.

If the type of the division line is longitudinal cutting of the TE link, the division line divides the TE link into one or two TE links with single ends opened, the topology where the TE link obtained by division is located being determined by the first controller, and a TE link attribute configuration is updated, at least including link bundle information, underlay TE topology and TE link layer network attributes.

If the type of the division line is longitudinal cutting of the TE node, one TE node is divided into two TE nodes, the first controller schedules an underlay network resource according to the VN topology where the TE node obtained by division is located and an underlay network diversity requirement, and updates a TE node configuration, at least including a new TE node ID, connectivity matrices, an underlay TE topology and the like. In the embodiment, two new nodes B (B2 and another node Bx) are obtained by division of D22, and it can be seen from the connectivity relationship that B2 is in the VN topology 2 and the other node Bx is in the original VN topology. For each new node B (B2 and Bx), the node ID is required to be updated. Because resources change after node division, the connectivity matrices, the underlay TE and the TE link and topology of the new nodes are all required to be updated according to a practical configuration.

When the type of the division line is transverse cutting of the TE link, the specified TE link is divided into multiple TE links and end nodes of the TE line are also divided. The first controller continues division based on the VN topology. In the embodiment, after the TE link, the node Bx and the node D are divided according to the division line D31, the TE nodes, B1 and D1 and the TE nodes B3 and D3 are obtained. The underlay network resource is scheduled according to the VN topology where the TE nodes B1 and D1 and the TE link B1D1 are located, a TE link bandwidth and the underlay network diversity requirement. The TE node configuration is updated, at least including the IDs of the TE nodes B1 and D1, the connectivity matrices, the underlay TE topology and the like. An attribute configuration of the TE link B1D1 is updated, at least including the link bundle information, underlay TE topology and TE link layer network attributes. Similarly, the first controller schedules the underlay network resource according to the VN topology where the TE nodes B3 and D3 and the TE link B3D3 are located, a TE link bandwidth and the underlay network diversity requirement. Configurations of the TE nodes B3 and D3 are updated, at least including the IDs of the TE nodes, the connectivity matrices, the underlay TE topology and the like. An attribute configuration of the TE link B3D3 is updated, at least including the link bundle information, underlay TE topology and TE link layer network attributes.

Through the solution of the embodiment, multiple division lines are analyzed and judged, so that division of the VN topology is implemented, and a complex VN may be conveniently managed and controlled.

The embodiments of the present disclosure also provide a storage medium, in which a computer program is stored, the computer program being configured to run to execute the steps in the network topology division method embodiment provided in the embodiments of the present disclosure.

In an embodiment, the storage medium may be configured to store a computer program configured to execute the following step.

In S1, a topology division request of a VN is received, the topology division request containing ID information of a specified VN to be divided, a type of a division line and a position of the division line.

In S2, a TE topology of the specified VN is divided according to the type of the division line and the position of the division line, the specified VN including a TE node and a TE link.

In S3, a new VN topology is constructed according to a TE node obtained by division and a TE link obtained by division.

In an embodiment, the storage medium in the embodiment may include, but not limited to, various medium capable of storing computer programs such as a U disk, a ROM, a RAM, a mobile hard disk, a magnetic disk or an optical disk.

The embodiments of the present disclosure also provide an electronic device, which includes a memory and a processor. A computer program is stored in the memory. The processor is configured to run the computer program to execute the steps in the network topology division method embodiment provided in the embodiments of the present disclosure.

In an embodiment, the electronic device may further include a transmission device and an input/output device. The transmission device is connected with the processor, and the input/output device is connected with the processor.

In an embodiment, the processor in the embodiment may be configured to execute the following steps through the computer program.

In S1, a topology division request of a VN is received, the topology division request containing ID information of a specified VN to be divided, a type of a division line and a position of the division line.

In S2, a TE topology of the specified VN is divided according to the type of the division line and the position of the division line, the specified VN including a TE node and a TE link.

In S3, a new VN topology is constructed according to a TE node obtained by division and a TE link obtained by division.

It is apparent that those skilled in the art should know that each module or each step of the embodiments of the present disclosure may be implemented through a universal computing device. They may be concentrated in a single computing device or distributed in a network formed by multiple computing devices. In an embodiment, they may be implemented by program codes executable for the computing devices and thus may be stored in a storage device for execution with the computing devices. Moreover, in some cases, the shown or described steps may be executed in sequences different from those described here, or may form various integrated circuit modules respectively, or multiple modules or steps therein may form a single integrated circuit module for implementation. Therefore, the present disclosure is not limited to any specific hardware and software combination.

The above is only the preferred embodiment of the present disclosure and not intended to limit the present disclosure. For those skilled in the art, the present disclosure may have various modifications and variations. Any modifications, equivalent replacements, improvements and the like made within the principle of the present disclosure shall fall within the scope of protection of the present disclosure.

1. A network technology division method, comprising:
receiving a topology division request of a Virtual Network (VN), the topology division request containing Identifier (ID) information of a specified VN to be divided, a type of a division line and a position of the division line;
dividing a Traffic Engineering (TE) topology of the specified VN according to the type of the division line and the position of the division line, the specified VN comprising a TE node and a TE link; and
constructing a new VN topology according to a TE node obtained by division and a TE link obtained by division.

2. The method as claimed in claim 1, wherein dividing the TE topology of the specified VN according to the type of the division line and the position of the division line comprises:
dividing the TE node and/or the TE link at the position of the division line according to the type of the division line for the TE topology.

3. The method as claimed in claim 2, wherein constructing the TE topology according to the type of the division line and the position of the division line comprises:
determining a TE node and/or TE link to be divided according to the type of the division line and the position of the division line; and
constructing the TE topology according to a connectivity relationship of a TE node obtained by division and/or a TE link obtained by division.

4. The method as claimed in claim 3, wherein acquiring information of the TE node and/or TE link to be divided according to the type of the division line and the position of the division line comprises at least one of:
when the type of the division line is longitudinal cutting of the TE link, specifying the TE link to be divided through a TE link ID;
when the type of the division line is longitudinal cutting of the TE node, specifying the TE node to be divided through a TE node ID; and
when the type of the division line is transverse cutting of the TE link, specifying the TE link to be divided and an end node of the TE link through the TE link ID.

5. The method as claimed in claim 2, wherein dividing the TE node and/or the TE link at the position of the division line according to the type of the division line for the TE topology comprises at least one of:
when the type of the division line is longitudinal cutting of the TE link, dividing a first IL link into one or two second TE links with single ends opened at the position of the division line;
when the type of the division line is longitudinal cutting of the TE node, dividing a first TE node into two second TE nodes at the position of the division line; and
when the type of the division line is transverse cutting of the TE link, dividing a third TE link into multiple fourth TE links at the position of the division line, and dividing a first end node of the third TE link into a corresponding second end node.

6. The method as claimed in claim 5, further comprising:
when the type of the division line is longitudinal cutting of the TE link, after the first TE link is divided into the one or two second TE links with the single ends opened at the position of the division line, updating configuration information of the second TE link;
when the type of the division line is longitudinal cutting of the TE node, after the first TE node is divided into the two second TE nodes at the position of the division line, updating configuration information of the second TE nodes; and
when the type of the division type is transverse cutting of the TE link, after the third TE link is divided into the multiple fourth links at the position of the division line and the first end node of the third TE link is divided into the corresponding second end node, updating configuration information of the fourth TE links and configuration information of the second end node.

7. The method as claimed in claim 1, wherein the topology division request further contains a topology alias of the divided specified VN.

8. The method as claimed in claim 1, wherein the type of the division line comprises at least one of:
longitudinal cutting of the TE link, configured to represent that a TE link between two TE nodes is divided into two TE links with single ends opened;
longitudinal cutting of the TE node, configured to represent that a TE node is divided into two or more parts; and
transverse cutting of the TE link, configured to represent that a specified TE link comprising end nodes is divided into multiple TE links.

9. A network topology division device, comprising:
a receiving module, configured to receive topology division request of a Virtual Network (VN), the topology division request containing Identifier (ID) information of a specified VN to be divided, a type of a division line and a position of the division line;
a division module, configured to divide a Traffic Engineering (TE) topology of the specified VN according to the type of the division line and the position of the division line, the specified VN comprising a TE node and a TE link; and
a construction module, configured to construct a new VN topology according to a TE node obtained by division and a TE link obtained by division.

10. The device as claimed in claim 9, wherein the division module comprises:
a division unit, configured to divide the TE node and/or the TE link at the position of the division line according to the type of the division line for the TE topology.

11. The device as claimed in claim 9, wherein the type of the division line comprises at least one of:
longitudinal cutting of the TE link, configured to represent that a TE link between two TE nodes is divided into two TE links with single ends opened;
longitudinal cutting of the TE node, configured to represent that a TE node is divided into two or more parts; and
transverse cutting of the TE link, configured to represent that a specified TE link comprising end nodes is divided into multiple TE links.

12. A storage medium, in which a computer program is stored, the computer program running to execute the method as claimed in claim 1.

13. An electronic device, comprising a memory and a processor, wherein a computer program is stored in the memory; and the processor is configured to run the computer program to execute the method as claimed in claim 1.

14. The method as claimed in claim 4, wherein the type of the division line comprises at least one of:
longitudinal cutting of the TE link, configured to represent that a TE link between two TE nodes is divided into two TE links with single ends opened;
longitudinal cutting of the TE node, configured to represent that a TE node is divided into two or more parts; and
transverse cutting of the TE link, configured to represent that a specified TE link comprising end nodes is divided into multiple TE links.

15. An electronic device, comprising a memory and a processor, wherein a computer program is stored in the memory; and the processor is configured to run the computer program to execute the method as claimed in claim 2.
